(19) United States
(12) Patent Application Publication
(10) Pub. No.: US 2002/0090146 A1
(43) Pub. Date: Jul. 11, 2002

(54) Hand recognition with position determination

(75) Inventors: Hans Jorg Heger, Munchen (DE); Wolfgang Kupper, Munchen (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/036,501

(22) Filed: Jan. 7, 2002

(30) Foreign Application Priority Data
Jan. 9, 2001 (DE) 10100615.2

(51) Int. Cl. G06K 9/36

(52) U.S. Cl. 382/291

(57) ABSTRACT

An arrangement, a method and a computer program for registering a hand on an arm, at least partially record an image of the hand and the arm. The arrangement has a searching unit to finding a part of the image with a high ratio of content to outer sides.

### CROSS REFERENCE TO RELATED APPLICATIONS

This application is based on and hereby claims priority to German Application No. 10100615.2 filed on Jan. 9, 2001 in Germany, the contents of which are hereby incorporated by reference.

### BACKGROUND OF THE INVENTION

The invention relates to an arrangement, a method and a program product for registering a hand on an arm, it being at least partly possible for an image of the hand and of the arm to be recorded.

Such arrangements are disclosed, for example, by U.S. Pat. Nos. 5,533,177, 5,751,843, 5,828,799, EP 0 560 779 B1, EP 0 713 592 B1, EP 0 800 145 A2 and WO 98/38533. In this case, an image of the hand and of the arm is recorded in the form of a digital image.

At least in the case of the arm, the image is generally recorded partly, so that the entire arm is not imaged.

While the aforementioned arrangements are used for the control of a data processing system via a user interface, arrangements also exist which are used for the authentication of users of biometric methods, that is to say the user is recognized on the basis of bodily features or characteristic behaviour. One established biometric method is authentication by recognizing the shape of the hand or part of the hand.

In this case, the hand of the user is placed onto a prefabricated plate with positioning aids in arrangements for hand recognition according to the prior art. The position of the hand is defined, down to the detail, by the physical aids, which, for example, are designed as small steel pins. An image of the static hand is then registered and further processed. On the basis of this image, the authentication of the user is carried out.

In addition to these arrangements and their modifications, two further methods, different in significant points, have been published. Both methods manage without the restriction of defining the exact hand position. EP 0 150 697 A1 achieves a non-contact measurement by the hand being held in approximately parallel light beams. For this purpose, the arrangement has a special chamber, in which the hand is held.

In U.S. Pat. No. 4,720,869, the hand may be placed onto a glass plate without any physical restrictions. However, the direction is implicitly predefined by the method used to record the image of the hand. The hand can therefore not be placed completely freely in this case either.

The common factor in all the arrangements is that, via their size and their construction, they ensure that only the hand contour is registered. The arrangements are dimensioned for objects of the size of a hand, and the contour supplied by the instrument is interpreted completely as a hand contour.

On this basis, the invention is based on the object of removing the restricting definition of the hand position during the hand recognition and therefore of making user-friendly arrangements and methods available.

### SUMMARY OF THE INVENTION

This object is achieved by an arrangement, a method and a program product having the features of the independent claims.

Accordingly, the arrangement has means for finding a part of the image in which an object with a large ratio between content and outer sides can be inscribed. Depending on whether a two-dimensional or three-dimensional image is concerned, the term content means the area or the volume, and the term outer sides means the circumference or the surface of the part.

The invention is based on the finding that the hand, more precisely the palm, represents the most compact area in a combination of arm, hand and fingers. As compared with this, the arm and finger are rather more elongate. The ratio of the magnitude of their content to their outer sides is therefore low. In the case of a three-dimensional image, this means that the ratio of volume to surface in the case of arm and fingers is very much lower than in the case of the hand. In the two-dimensional case, the ratio of area to circumference in the case of arm and fingers is very much lower than in the case of the hand.

How large the ratio has to be for reliable registration of the hand is determined by the anatomy of the persons to be authenticated. Here, any differentiating values should be selected for different cultural groups and different age groups. In general, reliable registration can be ensured by a suitably selected threshold value for the ratio.

Alternatively, however, such a threshold value can also be dispensed with if the high ratio of content to outer sides is approximately the largest ratio of content to outer sides which occurs in the image. This procedure is based on the assumption that the hand forms the most compact part, viewed absolutely, in the combination comprising arm, hand and fingers.

Finding the part of the image with a high ratio of content to outer sides can be implemented with difficulty in a data processing algorithm, starting from the image. For this purpose, first of all different parts have to be identified in an expedient way in the image and then the ratio has to be determined in each case. An arrangement constructed in this way can be implemented with the aid of a neural network.

However, on account of the simpler implementation needing less computing power, preference is given to the converse procedure, in which the starting point is not the image, instead a geometric object is inscribed repeatedly in the image. The geometric image is normally repeatedly inscribed in the image, which is only a different formulation of the same fact that a plurality of geometric objects are inscribed in the image. The part of the image where the geometric object can be inscribed at its largest is then found, in the other formulation where the largest of the geometric objects can be inscribed. In the case of this filling algorithm, the geometric preferably remains identical in its basic shape and only its dimensions are changed.

In euclidian metrology, in the two-dimensional case the circle and in the three-dimensional case the sphere have the greatest ratio of content to outer sides. Therefore, the geometric object is preferably a circle in the case of a two-dimensional image. This has been tried and tested in particular when the image is recorded from above or from below in relation to the hand. As an alternative to the circle, however, a rectangle or a suitably selected polygon can also be used.

In the three-dimensional case, a sphere can be used accordingly. Here, however, filling bodies more closely matched to the hand can also be used as geometric objects, such as a body of rotation in the form of a convex lens. Alternatively, however, a cube may also be used here.

The arrangement preferably has a device determining the position of the hand on the basis of the position of the part of the image. In this case, the hand position can be determined absolutely in the recording space recorded by the arrangement and/or relative to the arm and/or the fingers or parts thereof.

The latter is advantageous for hand recognition, that is to say for the authentication of the person to whom the hand belongs, since in this way characteristic features of the hand may be identified.

Furthermore, the center of the hand can be determined, for example by it being identified with the center of the inscribed geometric object. Following the registration of the center of the hand, the contour can be investigated for further characteristic hand features in the environment of the center.

Should further bodily parts or other objects have been recorded by the arrangement, then it is advantageous if said arrangement has a device identifying the image of hand and arm and in particular the hand in an environment. For example, an extended arm may easily be recognized by using its proportions of length to width.

In the case of a method of registering a hand on an arm, an image of the hand of the arm is at least partially recorded, and then a part of the image with a high ratio of content to outer sides is found. The method may be expediently advantageously configured by the features cited in the description and the claims relating to the arrangement.

A program product for a data processing system, which contains software code sections with which such a method can be carried out on the data processing system, may be carried out by suitable implementation of the method in a programming language. The software code sections are then stored for the purpose. In this case, a program product is understood to mean the program as a commercial product. It can be present in any desired form, for example on paper, a computer-readable data medium or distributed via a network.

The arrangement may be implemented, for example, by appropriate programming and setting up of a data processing system.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an image of hand and arm in a recorded area.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In an embodiment illustrated here by way of example, the arrangement contains a recording space in the form of a recording area of about 100×80 cm, which is recorded by a video camera. In order to avoid environmental effects, such as solar irradiation or shadowing, the scene is illuminated, approximately on the camera axis, with infrared light and the video camera operates with an infrared filter. A further increase in the recording accuracy is achieved by a retroreflective background. Because of the size of the recording area, the hand, the fingers and a varyingly large proportion of the arm of a user are registered.

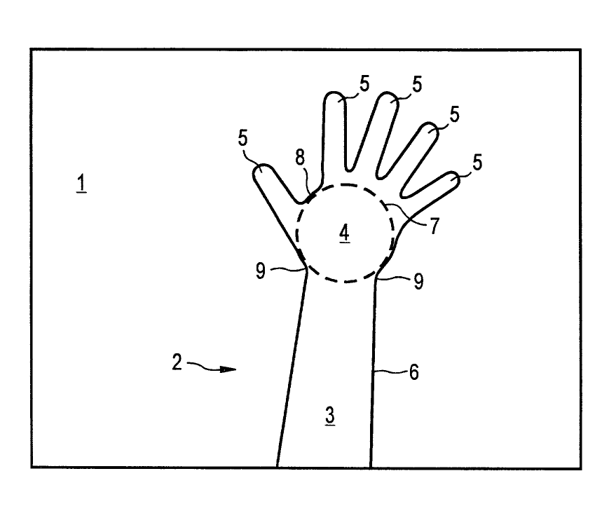

FIG. 1 shows the image recorded by the video camera. This image is forwarded in digitized form to a data processing system for processing. It contains the recording area 1 and a partial image 2 of arm 3 and hand 4.

In the exemplary embodiment illustrated, this image is two-dimensional. However, three-dimensional images are also conceivable, by operations being carried out with a plurality of video cameras or other recording instruments, and a three-dimensional image being produced from the data obtained from them.

Alternatively, for example, two two-dimensional images can also be produced with two video cameras, in order to increase the authentication accuracy.

For the hand recognition, substantially only the contour 6 of arm 3, hand 4 and fingers 5 is critical, so that the image 2 contains only this contour 6.

The image 2 is forwarded to a data processing system, which is set up in such a way that a method with the following steps is carried out.

In a first step, the image 2 is segmented in the conventional way. The result is a collection of contours of image contents contained in the image 2. The invention relates to the question as to which contour 6 of a plurality of contours which may be contained in the image contains a hand and which part of this contour 6 is a hand 4.

In a second step, the most promising candidate is selected. If, for example, further bodily parts should likewise be visible in the recording area 1, then, for example, an extended arm 3 can be recognized easily on account of its proportions, in particular using the ratio of length to width. The aim is to shorten the computing time since, given suitable selection—for example selection of the longest contour in the image—in the arrangement used, the arm-hand contour 6 is discovered reliably. Should uncertainties occur, the list of contours could be processed here ordered in accordance with a suitable feature.

In a third step, a filling algorithm is applied inward to the contour 6, starting from each edge point of the contour 6. This could be imagined in such a way that, starting from the edge, color runs into the contour 6. The result of this step is a good candidate for the center of the largest inscribed circle. The aim of the third step is to improve the performance, since processing all the points in the area within the contour 6 and, in each case, calculating the largest inscribed circle would last for a disproportionate length of time.

In a fourth step, the largest possible inscribed circle 7 is then calculated in a defined area, small in relation to the entire area of the contour 6, for each point. This circle usually comes to light at the connection between the thumb and index finger 8 and the heel of the hand 9. As a result, the hand 4 and its position is registered. In particular, the center of the hand is determined in the process, for example as the center of the circle.

In a fifth step, starting from the center of the hand, a test for further characteristic and necessary hand features is finally carried out.

The center of the hand, found in the manner described above, has proven to be very easily reproducible and is therefore of central significance for the quality of the features calculated in relation thereto. Without a center of the hand defined in this way,

1. the hand would be much more difficult to make out in the image and

2. the quality of the calculated features would be considerably poorer.

Starting from the circle 4, for example the wrists and the finger positions can be determined, in order to calculate the characteristic features of the hand 4 from them. In particular, conventional hand recognition can then be carried out.

By the circle 7, the position of the wrist can also be determined very well, and therefore also the points for dividing the contour of the hand 4 from the contour of the arm 3.

Inherent in all the embodiments of the invention is the advantage that only minimum effort is required of the user. It is merely necessary to position his or her hand in the recording area 1 in the typical authentication gesture. Undesired contact to surfaces also touched by other users, or the complicated insertion of the hand into a chamber is dispensed with.

1. An arrangement for registering a hand on an arm, comprising:
a supply unit to supply at least a partial image of the hand and the arm ; and
a search unit to retrieve a part of the image having the highest ratio of content to outer sides.

2. The arrangement as claimed in claim 1, wherein the high ratio of content to outer sides is approximately the highest ratio of content to outer sides.

3. The arrangement as claimed in claim 1, wherein the search unit are constructed such that a geometric object can be inscribed in the image.

4. The arrangement as claimed in claim 3, wherein the geometric object can be inscribed repeatedly at different positions in the image, and the part of the image can be found where the geometric object can be inscribed at its largest.

5. The arrangement as claimed in claim 3, wherein the geometric object is a circle, a rectangle, a polygon, a cube and/or a body of rotation, in particular a sphere.

6. The arrangement as claimed in claim 1, wherein the arrangement has means for determining the position of the hand on the basis of the position of the part of the image.

7. The arrangement as claimed in claim 1, wherein the arrangement is set up to carry out hand recognition.

8. The arrangement as claimed in claim 1, wherein the arrangement has means for identifying the hand in an environment.

9. The arrangement as claimed in claim 1, wherein the center of the hand can be determined.

10. A method of registering a hand on an arm, comprising:
at least partially recording an image of the hand and the arm, and
retrieving a part of the image with a high ratio of content to outer sides.

11. A computer readable medium storing a program to control a computer to perform a method comprising:
at least partially recording an image of the hand and the arm, and
retrieving a part of the image with a high ratio of content to outer sides.
